(19) United States
(12) Patent Application Publication
(10) Pub. No.: US 2023/0369724 A1
(43) Pub. Date: Nov. 16, 2023

(54) BATTERY PACK APPARATUS

(71) Applicant: Rivian IP Holdings, LLC, Irvine, CA (US)

(72) Inventors: Ehsan Baseri, Irvine, CA (US); Brandon Thayer, Aliso Viejo, CA (US); Casey Dunn, Mission Viejo, CA (US); Andrew Krasts, San Clemente, CA (US)

(21) Appl. No.: 17/740,555

(22) Filed: May 10, 2022

(51) Int. Cl. H01M 50/507; H01M 50/517

(52) U.S. Cl. CPC H01M 50/507; H01M 50/517; H01M 2220/20

(57) ABSTRACT

The apparatus can include a member and an end portion. The end portion can be disposed at an end of the member. The end portion can include a first opening and a second opening. The first opening can be configured to expose a portion of a first busbar. The second opening can be configured to expose a portion of a second busbar. The first busbar can be configured to couple with the second busbar.

### INTRODUCTION

Battery packs can be a source of electrical power. Battery packs can be assembled with various components.

### SUMMARY

Battery packs, such as those used for electric vehicles, can have busbar assemblies. An insufficiently secured busbar assembly can cause ineffective or inefficient current transfer between components of the battery pack. The technical solution described herein provides a busbar assembly with openings that can expose portions of the busbars to provide access for probes or other elements to contact the busbars to facilitate measuring a resistance across the busbar assembly. The resistance can be used to verify that the connections of the busbar assembly are secured appropriately.

At least one aspect is directed to an apparatus. The apparatus can include a member and an end portion. The end portion can be disposed at an end of the member. The end portion can include a first opening and a second opening. The first opening can be configured to expose a portion of a first busbar. The second opening can be configured to expose a portion of a second busbar. The first busbar can be configured to couple with the second busbar.

At least one aspect is directed to a battery pack. The battery pack can include a battery module and a busbar assembly. The busbar assembly can be coupled with the battery module. The busbar assembly can include a first busbar. The busbar assembly can include a second busbar coupled with the first busbar. The busbar assembly can include a casing configured to receive the first busbar and interface with the second busbar. The casing can include a plurality of openings. The plurality of openings can include a first opening and a second opening. The first opening can expose a portion of the first busbar and the second opening can expose a portion of the second busbar.

At least one aspect is directed to a method. The method can include receiving, by a cavity of a casing, a first busbar. The casing can include a member and an end portion. The end portion can be disposed at an end of the member. The end portion can define a first opening and a second opening. The method can include interfacing the end portion of the casing with a second busbar. The method can include coupling the first busbar with the second busbar. The method can include exposing a portion of the first busbar with the first opening. The method can include exposing a portion of the second busbar with the second opening.

At least one aspect is directed to an electric vehicle. The electric vehicle can include a battery pack. The battery pack can include a battery module. The battery pack can include a busbar assembly coupled with the battery module. The busbar assembly can include a first busbar, a second busbar, and a casing. The casing can surround at least a portion of the first busbar. The casing can include a first opening exposing a portion of the first busbar 405. The casing can include a second opening exposing a portion of the second busbar. The first busbar can be coupled with the second busbar.

At least one aspect is directed to a method. The method can include providing a busbar assembly. The busbar assembly can include a first busbar. The busbar assembly can include a second busbar coupled with the first busbar. The busbar assembly can include a casing configured to surround a portion of the first busbar. The casing can include a first opening and a second opening. The first opening can expose a portion of the first busbar and the second opening can expose a portion of the second busbar.

At least one aspect is directed to an apparatus. The apparatus can include a first busbar. The apparatus can include a second busbar coupled with the first busbar. The apparatus can include a casing surrounding at least a portion of the first busbar. The casing can include an end portion. The end portion of the casing can include a first opening and a second opening. The first opening can expose a portion of the first busbar and the second opening can expose a portion of a second busbar.

These and other aspects and implementations are discussed in detail below. The foregoing information and the following detailed description include illustrative examples of various aspects and implementations, and provide an overview or framework for understanding the nature and character of the claimed aspects and implementations. The drawings provide illustration and a further understanding of the various aspects and implementations, and are incorporated in and constitute a part of this specification. The foregoing information and the following detailed description and drawings include illustrative examples and should not be considered as limiting.

### BRIEF DESCRIPTION OF THE DRAWINGS

The accompanying drawings are not intended to be drawn to scale. Like reference numbers and designations in the various drawings indicate like elements. For purposes of clarity, not every component may be labeled in every drawing. In the drawings:

FIG. 1 depicts an example electric vehicle, in accordance with some aspects.

FIG. 2A depicts an example battery pack, in accordance with some aspects.

FIG. 2B depicts example battery modules, in accordance with some aspects.

FIG. 3 depicts a top view of an example apparatus, in accordance with some aspects.

FIG. 4 depicts a side cross-sectional view of an example apparatus, in accordance with some aspects.

FIG. 5 depicts a perspective view of an example apparatus, in accordance with some aspects.

FIG. 6 depicts a side cross-sectional view of an example busbar assembly, in accordance with some aspects.

FIG. 7 depicts a top view of an example battery pack, in accordance with some aspects.

FIG. 8 depicts a flow diagram illustrating an example method to assemble a busbar assembly, in accordance with some aspects.

FIG. 9 depicts a flow diagram illustrating an example method to provide an apparatus, in accordance with some aspects.

FIG. 10 depicts a flow diagram illustrating an example method to verify a connection, in accordance with some aspects.

### DETAILED DESCRIPTION

Following below are more detailed descriptions of various concepts related to, and implementations of, methods, apparatuses, and systems to connect or verify connections of a busbar assembly. The various concepts introduced above and discussed in greater detail below may be implemented in any of numerous ways.

The present disclosure is generally directed to systems and methods of connecting or verifying a connection between bolted joints of a busbar assembly by providing access points for probes to measure a resistance over the busbar assembly.

A busbar assembly can connect a first battery module of a battery pack with a second battery module of a battery pack. The busbar assembly can include a module-to-module (M2M) busbar, a first terminal busbar and a second terminal busbar. The first terminal busbar can be coupled with a first battery module and the second terminal busbar can be coupled with a second battery module. The M2M busbar can couple with the first terminal busbar and can couple with the second terminal busbar. The M2M busbar can couple with the terminal busbars via any type of fastener (e.g., a bolt). To verify a proper connection between the M2M busbar and the terminal busbars, a resistance of the busbar assembly can be measured. For example, a proper coupling between the M2M busbar and a terminal busbar can provide a path for current to flow with a resistance below a predetermined threshold. If a probe measures a resistance below the threshold, the connection can be considered properly secured.

The busbar assembly can include a cover configured to separate the M2M busbar and the terminal busbar from other conductive elements within the battery pack. The cover can include at least one opening configured to provide access for a probe to contact the M2M busbar and at least one opening configured to provide access for a probe to contact a terminal busbar. The first and second opening can have a size, shape, and location configured to provide access for the probe to measure a resistance over the busbar assembly, as well as provide adequate spacing and clearance between exposed conductive materials within the battery pack.

The disclosed solutions have a technical advantage of providing an easy method for verifying a secure connection between busbars. The technical solutions described herein can measure a resistance across an assembly. In this example, resistance can be measured without relying on monitoring the torque and angle of the fastener. The disclosed technical solution provides sufficient access to the busbars to measure a resistance over the system while maintaining the necessary clearances between conductive elements. The system provides easy access to the busbar assembly, and therefore an easy means of verifying the connection of the busbar assembly, during both manufacturing and maintenance.

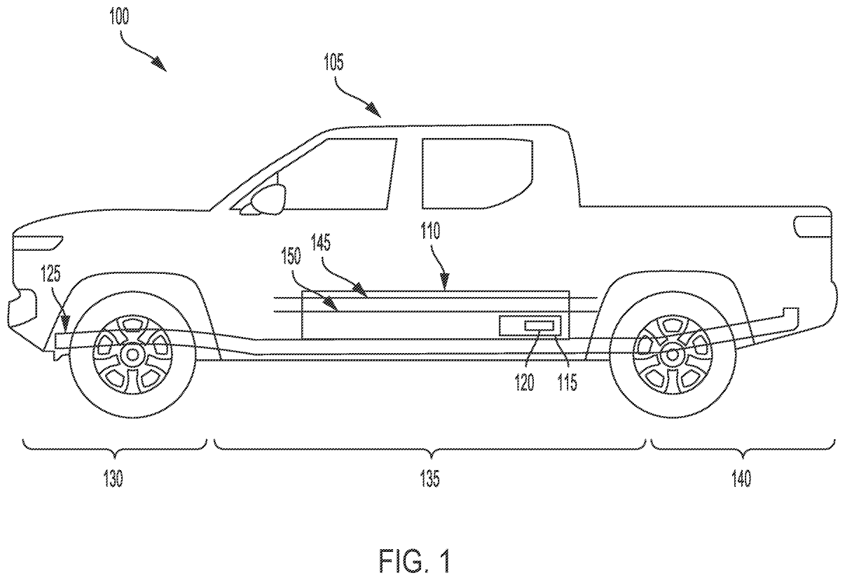

FIG. 1 depicts is an example cross-sectional view 100 of an electric vehicle 105 installed with at least one battery pack 110. Electric vehicles 105 can include electric trucks, electric sport utility vehicles (SUVs), electric delivery vans, electric automobiles, electric cars, electric motorcycles, electric scooters, electric passenger vehicles, electric passenger or commercial trucks, hybrid vehicles, or other vehicles such as sea or air transport vehicles, planes, helicopters, submarines, boats, or drones, among other possibilities. The battery pack 110 can also be used as an energy storage system to power a building, such as a residential home or commercial building. Electric vehicles 105 can be fully electric or partially electric (e.g., plug-in hybrid) and further, electric vehicles 105 can be fully autonomous, partially autonomous, or unmanned. Electric vehicles 105 can also be human operated or non-autonomous. Electric vehicles 105 such as electric trucks or automobiles can include on-board battery packs 110, battery modules 115, or battery cells 120 to power the electric vehicles. The electric vehicle 105 can include a chassis 125 (e.g., a frame, internal frame, or support structure). The chassis 125 can support various components of the electric vehicle 105. The chassis 125 can span a front portion 130 (e.g., a hood or bonnet portion), a body portion 135, and a rear portion 140 (e.g., a trunk, payload, or boot portion) of the electric vehicle 105. The battery pack 110 can be installed or placed within the electric vehicle 105. For example, the battery pack 110 can be installed on the chassis 125 of the electric vehicle 105 within one or more of the front portion 130, the body portion 135, or the rear portion 140. The battery pack 110 can include or connect with at least one busbar, e.g., a current collector element. For example, the first busbar 145 and the second busbar 150 can include electrically conductive material to connect or otherwise electrically couple the battery modules 115 or the battery cells 120 with other electrical components of the electric vehicle 105 to provide electrical power to various systems or components of the electric vehicle 105.

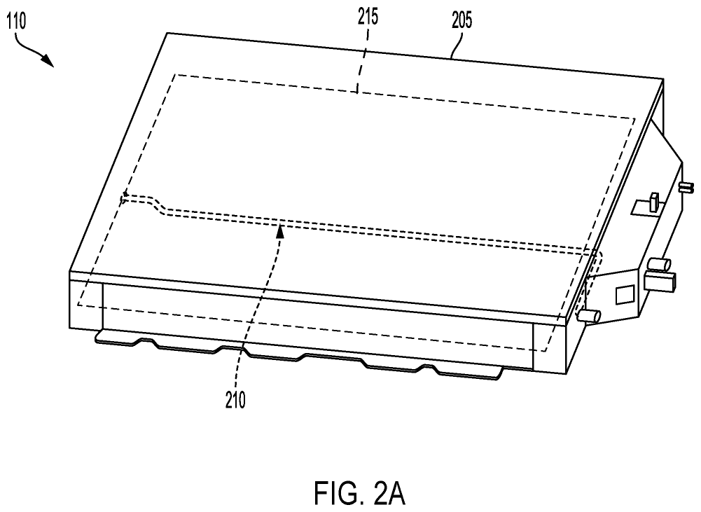

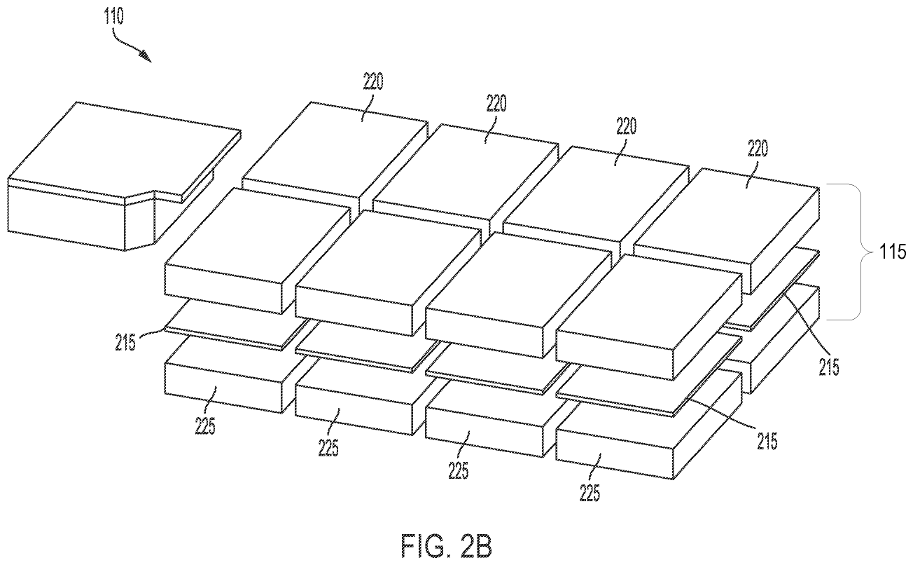

FIG. 2A depicts an example battery pack 110. Referring to FIG. 2A, among others, the battery pack 110 can provide power to electric vehicle 105. Battery packs 110 can include any arrangement or network of electrical, electronic, mechanical or electromechanical devices to power a vehicle of any type, such as the electric vehicle 105. The battery pack 110 can include at least one housing 205. The housing 205 can include at least one battery module 115 or at least one battery cell 120, as well as other battery pack components. The housing 205 can include a shield on the bottom or underneath the battery module 115 to protect the battery module 115 from external conditions, for example if the electric vehicle 105 is driven over rough terrains (e.g., off-road, trenches, rocks, etc.) The battery pack 110 can include at least one cooling line 210 that can distribute fluid through the battery pack 110 as part of a thermal/temperature control or heat exchange system that can also include at least one thermal component (e.g., cold plate) 215. The thermal component 215 can be positioned in relation to a top submodule and a bottom submodule, such as in between the top and bottom submodules, among other possibilities. The battery pack 110 can include any number of thermal components 215. For example, there can be one or more thermal components 215 per battery pack 110, or per battery module 115. At least one cooling line 210 can be coupled with, part of, or independent from the thermal component 215.

FIG. 2B depicts example battery modules 115, and FIG. 2C depicts an example cross sectional view of a battery cell 120. The battery modules 115 can include at least one submodule. For example, the battery modules 115 can include at least one first (e.g., top) submodule 220 or at least one second (e.g., bottom) submodule 225. At least one thermal component 215 can be disposed between the top submodule 220 and the bottom submodule 225. For example, one thermal component 215 can be configured for heat exchange with one battery module 115. The thermal component 215 can be disposed or thermally coupled between the top submodule 220 and the bottom submodule 225. One thermal component 215 can also be thermally coupled with more than one battery module 115 (or more than two submodules 220, 225). The battery submodules 220, 225 can collectively form one battery module 115. In some examples each submodule 220, 225 can be considered as a complete battery module 115, rather than a submodule.

The battery modules 115 can each include a plurality of battery cells 120. The battery modules 115 can be disposed within the housing 205 of the battery pack 110. The battery modules 115 can include battery cells 120 that are cylindrical cells or prismatic cells, for example. The battery module 115 can operate as a modular unit of battery cells 120. For example, a battery module 115 can collect current or electrical power from the battery cells 120 that are included in the battery module 115 and can provide the current or electrical power as output from the battery pack 110. The battery pack 110 can include any number of battery modules 115. For example, the battery pack can have one, two, three, four, five, six, seven, eight, nine, ten, eleven, twelve or other number of battery modules 115 disposed in the housing 205. It should also be noted that each battery module 115 may include a top submodule 220 and a bottom submodule 225, possibly with a thermal component 215 in between the top submodule 220 and the bottom submodule 225. The battery pack 110 can include or define a plurality of areas for positioning of the battery module 115. The battery modules 115 can be square, rectangular, circular, triangular, symmetrical, or asymmetrical. In some examples, battery modules 115 may be different shapes, such that some battery modules 115 are rectangular but other battery modules 115 are square shaped, among other possibilities. The battery module 115 can include or define a plurality of slots, holders, or containers for a plurality of battery cells 120.

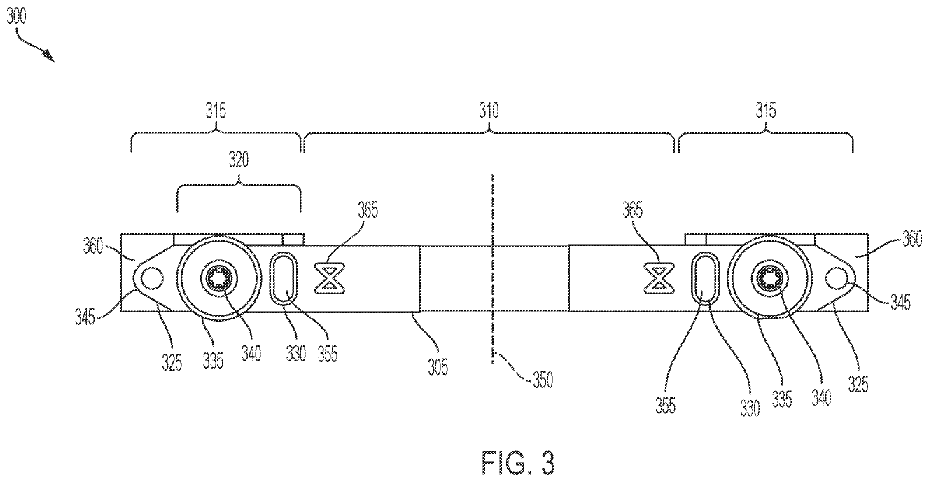

FIG. 3 depicts an example apparatus 300. Apparatus 300 can include at least one casing 305. The casing 305 can provide insulation for at least one busbar to prevent the busbar from contacting other conductive components. For example, casing 305 can surround a majority of a busbar to prevent other conductive components from contacting the busbar. The casing 305 can leave a portion of the busbar exposed. The exposed portion of the busbar can interface with a component such that current from the component can be transferred to another component. For example, the exposed portion of the busbar can interface with a battery module 115 or another busbar coupled with the battery module 115 to transfer current from the battery module 115 to another component (e.g., another battery module 115, an electrical component of the electric vehicle 105). Casing 305 can include at least one member 310. The member 310 can extend between a first connection point and a second connection point of a busbar assembly. For example, the member 310 can be or include an elongated portion configured to extend between two busbars. Member 310 can include at least one protrusion 365. Protrusion 365 can be a gripping feature. For example, protrusion 365 can facilitate automated busbar assembly or installation. Protrusion 365 can be any shape or configuration capable of facilitating the gripping function.

Casing 305 can include at least one end portion 315. The end portion 315 can be disposed at an end of the member 310. The end portion 315 can be integrally formed with the member 310. The end portion 315 can comprise a body 320 and a tip 325. The body 320 of the end portion 315 can define a first opening, shown as M-opening 330. The end of the member 310 and the beginning of the end portion 315 can be defined by the location of the first opening, wherein the first opening is a part of the end portion 315. The M-opening 330 can be configured to expose a portion of a first busbar, shown as M-busbar 355. Exposing the portion of the M-busbar 355 can include, for example, showing, uncovering, or providing access to the M-busbar. For example, the casing 305 can extend over the M-opening 330, but can be configured to be punctured or can be flexible in order for a device to be inserted into the M-opening 330 and contact the M-busbar 355. The M-opening 330 can have an oblong shape. For example, the M-opening 330 can be an oval. The body 320 of the end portion 315 can include a housing 335. The housing 335 can receive a fastener. The housing 335 can define a housing aperture 340. The housing aperture 340 can facilitate securing of the fastener to couple the M-busbar 355 with a second busbar, shown as T-busbar 360. For example, a device can extend through the housing aperture 340 to cause the fastener to secure the M-busbar 355 with the T-busbar 360. The tip 325 of the end portion 315 can define a second opening, shown as T-opening 345. The T-opening 345 can be configured to expose a portion of the T-busbar 360. The T-opening 345 can have a different shape than the M-opening 330. For example, the T-opening 345 can have a round shape. For example, the T-opening 345 can be a circle. The M-opening 330 and the T-opening 345 can have any shape and size configured to allow access to the busbars 355, 360 to measure a resistance over the busbars 355, 360. For example, the size and shape of the openings 330, 345 can depend on a size of a probe used to measure the resistance.

The M-opening 330 can be disposed a first distance away from a centerline 350 of the casing 305. The T-opening 345 can be disposed a second distance away from the centerline 350. The first distance can be shorter than the second distance. For example, the M-opening 330 can be closer to the centerline 350 than the T-opening 345. The first distance can also be longer than the second distance. For example, the M-opening 330 can be farther away from the centerline 350 than the T-opening 345. The M-opening 330 can be disposed at least a predetermined distance away from the T-opening 345. For example, the predetermined distance can be based on an industry standard. For example, the predetermined distance can be 10 mm. The predetermined distance can be more than 10 mm or less than 10 mm. The housing 335 can be disposed between the M-opening 330 and the T-opening 345. For example, the M-opening 330 can be disposed on a first side of the housing 335 and the T-opening 345 can be disposed on a second side of the housing 335. The

Casing 305 can include a plurality of end portions 315. For example, casing 305 can include a first end portion 315 and a second end portion 315. The first end portion 315 can define a first opening and a second opening. The first opening can be a first M-opening 330 and the second opening can be a first T-opening 345. The second end portion 315 can define a third opening and a fourth opening. The third opening can be a second M-opening 330 and the fourth opening can be a second T-opening 345. The first M-opening 330 can be configured to expose a first portion of a first busbar (the M-busbar 355), the second M-opening 330 can be configured to expose a second portion of the first busbar (the M-busbar 355), the first T-opening 345 can be configured to expose a portion of a second busbar (a first T-busbar 360), and the second T-opening 345 can be configured to expose a portion of a third busbar (a second T-busbar 360). The first and second M-openings 330 can be disposed a first distance away from the centerline 350 of the casing 305 and the first and second T-openings 345 can be disposed a second distance away from the centerline 350.

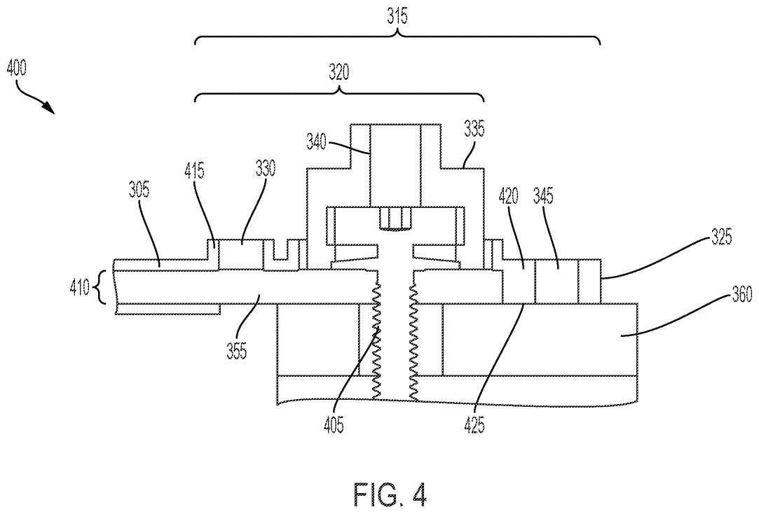

FIG. 4 depicts a side cross-sectional view of an example busbar assembly 400. The busbar assembly 400 can include a casing 305, a first busbar, shown as M-busbar 355, and a second busbar, shown as T-busbar 360. M-busbar 355 can be a module-to-module (M2M) busbar configured to electrically couple a first battery module with a second battery module. T-busbar 360 can be a busbar coupled with a battery module configured to receive current for the battery module or provide current from the battery module. The M-busbar 355 can couple with the T-busbar 360. For example, a fastener 405 can be disposed in housing 335 of the casing 305. The fastener 405 can be a bolt. The fastener 405 can be configured to couple the M-busbar 355 with the T-busbar 360. The T-busbar 360 can be configured to couple the first busbar with at least one of the first battery module and the second battery module.

The member 310 and the end portion 315 of the casing 305 can define a cavity 410. The cavity 410 can extend from the member 310 to an inner wall of the tip 325 of the end portion 315. For example, the member 310 can define a first portion of the cavity 410 and the body 320 of the end portion 315 can define a second portion of the cavity 410. The cavity 410 can be configured to receive the M-busbar 355. The casing 305 and the M-busbar 355 can be integrally formed such that the casing 305 and the M-busbar 355 are a single component. For example, the casing 305 can be an overmold molded over the M-busbar 355. The M-busbar 355 can extend under the M-opening 330 and under the housing 335 to the sidewall of the tip 325. The M-busbar 355 can extend over the M-opening 330 and over the housing 335 if the casing 305 is inverted.

End portion 315 can include at least one projection 415. The projection 415 can define the M-opening 330. The projection 415 can extend away from a surface of the casing 305 in a direction away from the cavity 410. The M-opening 330 can extend from an end of the projection 415 to the cavity 410. The M-opening 330 can expose a portion of the M-busbar 355 disposed within the cavity 410. The projection 415 can be configured to prevent external elements from contacting the M-busbar 355. A height of the projection 415 can be a predetermined height. The height can extend from the surface of the casing 305 to the end of the projection 415. The predetermined height can be based on an industry standard or best practices. The predetermined height can be, for example, 2.3 mm (plus or minus 10%). The predetermined height can also be more or less than 2.3 mm. The height of the projection 415 can affect the depth of the M-opening 330 and vice versa. The depth of the M-opening can be based on an industry standard or best practices. For example, the depth of the M-opening 330 can be 3.45 mm (plus or minus 10%). The depth of the M-opening 330 can also be more or less than 3.45 mm.

The tip 325 of the end portion 315 can have a top surface 420 and a bottom surface 425. The top surface 420 can be a top surface of the casing 305. The bottom surface 425 can align with a bottom of the M-busbar 355 disposed in the cavity 410 of the casing 305. The bottom surface 425 of the tip 325 can be configured to interface with the T-busbar 360. The tip 325 can define a T-opening 345. The T-opening 345 can extend through the tip 325 from the top surface 420 to the bottom surface 425. The T-opening 345 can expose a portion of the T-busbar 360. A depth of the T-opening 345 can be based on industry standards or best practices. For example, the depth of the T-opening 345 can prevent external elements from contacting the T-busbar 360. The depth of the T-opening 345 can be, for example, 4.95 mm (plus or minus 10%). The depth of the T-opening 345 can be more or less than 4.95 mm. The depth of the M-opening 330 can be less than the depth of the T-opening 345. The depth of the M-opening 330 can also be more than or equal to the depth of the T-opening 345. The tip 325 can be disposed on a first side of the housing 335 and the projection 415 can be disposed on a second side of the housing 335. The second side of the housing 335 can be closer to the member 310 than the first side such that the M-opening 330 can be closer to the member 310 than the T-opening 345.

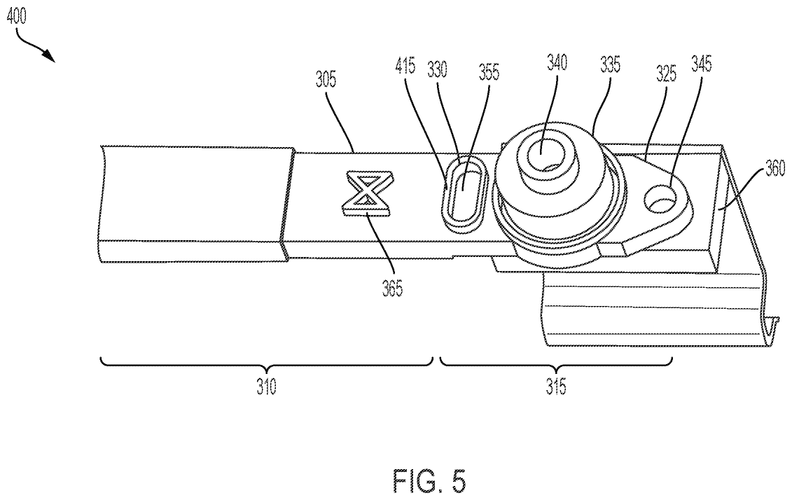

FIG. 5 depicts a perspective view of example busbar assembly 400. Busbar assembly can include the casing 305, the M-busbar 355, and the T-busbar 360. Casing 305 can include the member 310 and the end portion 315. The projection 415 can define the M-opening 330. The M-opening 330 can expose a portion of the M-busbar 355. The projection 415 and the M-opening 330 can be disposed on a first side of the housing 335. The tip 325 can define the T-opening 345. The T-opening 345 can expose a portion of the T-busbar 360. The tip 325 and the T-opening 345 can be disposed on a second side of the housing 335.

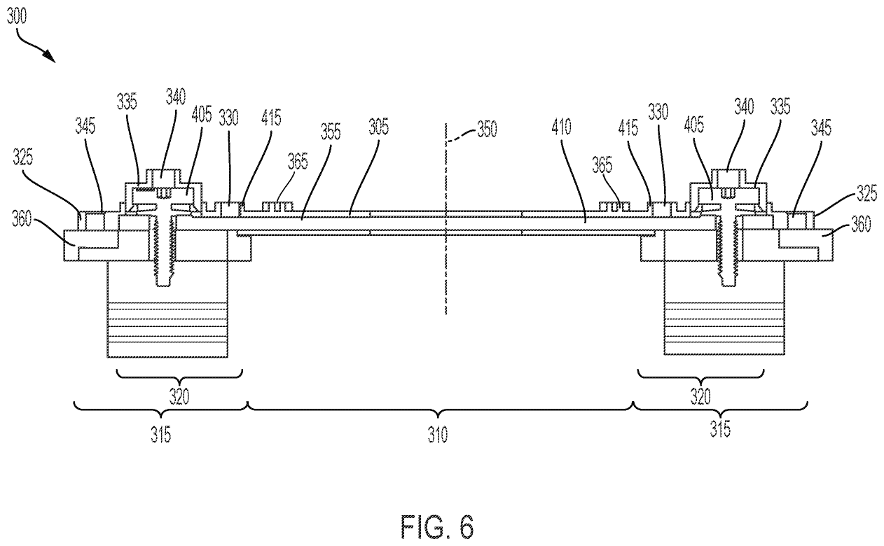

FIG. 6 depicts a cross-sectional side view of example busbar assembly 400. Busbar assembly 400 can include a casing 305, a first busbar, shown as M-busbar 355, a second busbar, shown as a first T-busbar 360, and a third busbar, shown as a second T-busbar 360. Casing 305 can include a member 310. Member 310 can extend between the first T-busbar 360 and the second T-busbar 360. Member 310 can be an elongated portion. The member 310 can interface with a bracket of a battery pack. For example, the bracket can support the member 310. The casing 305 can include a plurality of end portions 315, including a first end portion 315 and a second end portion 315. The first end portion 315 can extend from a first end of the member 310 and the second end portion 315 can extend from a second end of the member 310. The first and second end portion 315 can be integrally formed with the member 310. The first end portion 315 can include a first tip 325 and the second end portion 315 can include a second tip 325. The casing 305 can define a cavity 410 configured to receive the M-busbar 355. For example, the member 310, the first end portion 315, and the second end portion 315 can define the cavity 410. The cavity 410 can extend between the first tip 325 and the second tip 325. The M-busbar 355 can be integrally formed with the casing 305. For example, the casing 305 can be an overmold molded together with the M-busbar 355.

The casing 305 can expose a first section of the M-busbar 355 and a second section of the M-busbar 355. The first section can be configured to interface with the first T-busbar 360 and the second section can be configured to interface with the second T-busbar 360. The M-busbar 355 can be electrically coupled with the first and second T-busbars 360. For example, a first fastener 405 can be disposed in a first housing 335 of the first end portion 315. A second fastener 405 can be disposed in a second housing 335 of the second end portion 315. The first fastener 405 can couple the M-busbar 355 with the first T-busbar 360 and the second fastener 405 can couple the M-busbar 355 with the second T-busbar 360. The coupling of the M-busbar 355 with the first and second T-busbars 360 can create an electrical connection between the first T-busbar 360 and the second T-busbar 360. The electrical connection between the first T-busbar 360 and the second T-busbar 360 can facilitate a transfer of current between a first battery module and a second battery module. For example, the first T-busbar 360 can be coupled with a first battery module and the second T-busbar 360 can be coupled with the second battery module. Current can transfer between the first and second battery modules via the two T-busbars 360 and the M-busbar 355.

A proper coupling between the M-busbar 355 and the first and second T-busbars 360 can include an electrical connection between the first T-busbar 360 and the second T-busbar 360. To verify a proper coupling of the M-busbar 355 with the first and second T-busbars 360, a resistance can be measured across the busbar assembly 400. The first end portion 315 of the casing 305 can include a first opening, shown as first M-opening 330, and a second opening, shown as first T-opening 345. The second end portion 315 can include a third opening, shown as second M-opening 330, and a fourth opening, shown as second T-opening 345. The openings can be disposed symmetrically about the casing 305. For example, the first and second M-openings 330 can be disposed a first distance from a centerline 350 of the casing 305 and on different sides of the centerline 350. The first and second T-openings 345 can be disposed a second distance from the centerline 350 and on different sides of the centerline 350. The first distance can be shorter than the second distance. The first M-opening 330 can expose a first portion of the M-busbar 355 and the second M-opening 330 can expose a second portion of the M-busbar 355. The first T-opening 345 can expose a portion of the first T-busbar 360 and the second T-opening 345 can expose a portion of the second T-busbar 360. The M-openings 330 and the T-openings 345 can provide access for a device to contact the busbars 355, 360 in order to measure a resistance across the busbar assembly 400. For example, a probe can extend through some, all, or any combination of the openings 330, 345 to contact the busbars 355, 360. The probe can determine a resistance across the busbar assembly 400. The resistance can be compared to a threshold. The threshold can identify when an electrical connection across the busbar assembly 400 is adequate. For example, if the resistance is above the threshold, the electrical connection can be determined to be faulty and not adequate. A proper electrical connection can indicate a proper physical connection between the busbars 355, 360.

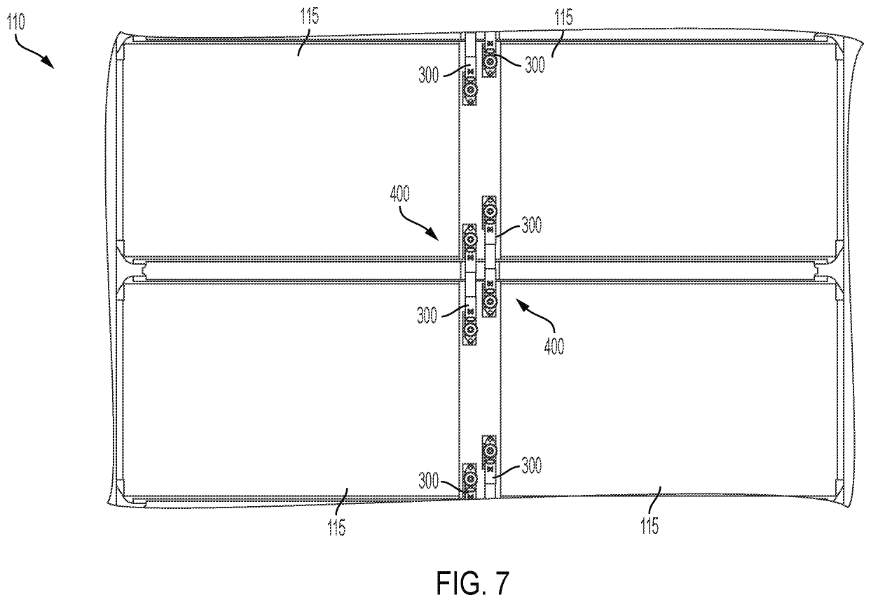

FIG. 7 depicts a top view of an example battery pack 110. Battery pack 110 can include at least one battery module 115 and at least one busbar assembly 400. The busbar assembly 400 can be coupled with the battery module 115. The busbar assembly 400 can include an apparatus 300, a first busbar (e.g., M-busbar 355), and a second busbar (e.g., T-busbar 360). The apparatus 300 can be or can include a casing 305. The casing 305 can be configured to receive the M-busbar 355. For example, the casing 305 can define a cavity 410 configured to receive the M-busbar 355. The casing 305 can surround at least a portion of the M-busbar 355. The casing 305 can be configured to interface with the T-busbar 360. For example, a tip 325 of an end portion 315 of the casing 305 can interface with (e.g., rest on) the T-busbar 360. The casing 305 can include a plurality of openings. For example, the casing can include a first opening, shown as M-opening 330, and a second opening, shown as T-opening 345. The M-opening can expose a portion of the M-busbar 355 and the T-opening 345 can expose a portion of the T-busbar 360.

Battery pack 110 can include a plurality of battery modules 115. For example, battery pack 110 can include a first, second, third, and fourth battery module 115. Battery pack 110 can include at least one busbar assembly 400. The busbar assembly 400 can include an apparatus 300, a first busbar, shown as M-busbar 355, a second busbar, shown as first T-busbar 360, and a third busbar, shown as second T-busbar 360. The first battery module 115 can couple with the busbar assembly 400 via the first T-busbar 360 and the second battery module 115 can couple with the busbar assembly 400 via the second T-busbar 360. Battery pack 110 can include a plurality of busbar assemblies 400. For example, battery pack 110 can include a first busbar assembly 400 comprising a first apparatus 300 and a second busbar assembly 400 comprising a second apparatus 300. The first busbar assembly 400 can be configured to electrically couple the first battery module 115 with the second battery module 115 and the second busbar assembly 400 can be configured to electrically couple the third battery module 115 with the fourth battery module 115.

The first battery module 115 can be coupled with a first T-busbar 360 and the second battery module 115 can be coupled with a second T-busbar 360. The apparatus 300 can include a casing 305. The casing 305 can include a member 310, a first end portion 315 and a second end portion 315. The member 310 can be an elongated portion. The elongated portion can extend between the first T-busbar 360 and the second T-busbar 360. The first end portion 315 can be disposed at a first end of the member 310 and the second end portion 315 can be disposed at a second end of the member 310. The casing 305 can define a cavity configured to receive a M-busbar 355. The M-busbar 355 can electrically couple the first T-busbar 360 with the second T-busbar 360. For example, the M-busbar 355 can interface with both the first and second T-busbars 360. The M-busbar 355, the first T-busbar 360, and the second T-busbar 360 can electrically couple the first battery module 115 with the second battery module 115. The first end portion 315 can define a first opening, shown as M-opening 330, and a second opening, shown as first T-opening 345. The second end portion 315 can define a third opening, shown as second M-opening 330, and a fourth opening, shown as second T-opening 345. The first and second M-openings 330 can expose a portion of the M-busbar 355. The first and second M-openings 330 can have an oblong shape. The first T-opening 345 can expose a portion of the first T-busbar 360 and the second T-opening 345 can expose a portion of the second T-busbar 360. The first and second T-openings 345 can have a circular shape. A quality of the physical connections between the first and second battery modules 115 can be determined by measuring a resistance over the busbar assembly 400. The third battery module 115 and the fourth battery module 115 can be electrically coupled by the same or similar system as the first and second battery modules 115.

The battery pack 110 can include a plurality of battery modules 115 disposed in series. For example, the battery pack 110 can include a first, second, and third battery module 115. The first battery module 115 can be electrically coupled with the second battery module 115, and the second battery module 115 can be electrically coupled with the third battery module 115. A first busbar assembly 400 comprising a first apparatus 300 can couple the first battery module 115 with the second battery module 115 and a second busbar assembly 400 comprising a second apparatus 300 can couple the second battery module 115 with the third battery module 115.

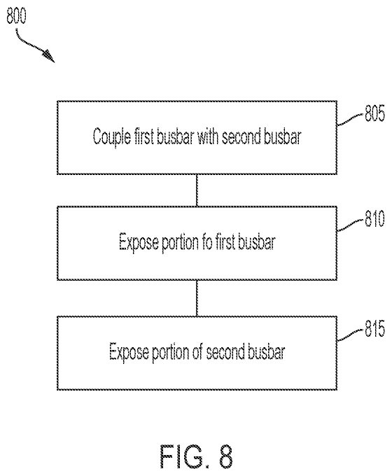

FIG. 8 depicts an example method 800 to assemble a busbar assembly 400. Method 800 can include coupling a first busbar with a second busbar (Act 805), exposing a portion of the first busbar (Act 810), and exposing a portion of the second busbar (Act 815). Act 805 of coupling the first busbar with the second busbar can include receiving the first busbar. The first busbar can be a M-busbar 355. A casing 305 can define a cavity 410 configured to receive the M-busbar 355. The casing 305 can include a member 310 and an end portion 315. The end portion 315 can be disposed at an end of the member 310. The end portion 315 can define a first opening and a second opening. The first opening can be a M-opening 330 and the second opening can be a T-opening 345. The M-opening 330 can have an oblong shape. The T-opening 345 can have a circular shape. Act 805 can include disposing the M-busbar 355 within the cavity 410 of the casing 305. Act 805 can also include overmolding the casing 305 with the M-busbar 355 such that the casing 305 and the M-busbar 355 are a single component.

Act 805 can include interfacing the casing 305 with a second busbar. The second busbar can be a T-busbar 360. The end portion 315 of the casing 305 can include a tip 325. The tip 325 can have a surface configured to interface with the T-busbar 360. For example, the tip 325 can rest on the T-busbar 360. Interfacing the tip 325 with the T-busbar 360 can include interfacing the M-busbar 355 with the T-busbar 360.

Act 805 can also include interfacing the casing 305 with a third busbar. The second busbar can be a first T-busbar 360 and the third busbar can be a second T-busbar 360. The casing 305 can include a first end portion 315 and a second end portion 315. The first end portion 315 can include a first tip 325 and the second end portion 315 can include a second tip 325. The first tip 325 can interface with the first T-busbar 360 and the second tip 325 can interface with the second T-busbar 360. Interfacing the tips 325 with the busbars 360 can include interfacing the M-busbar 355 with the T-busbars 360. For example, a first side of the M-busbar 355 can interface with the first T-busbar 360 and a second side of the M-busbar 355 can interface with the second T-busbar 360.

Act 805 can include coupling the first busbar with the second busbar. For example, act 815 can include coupling the M-busbar 355 with the first T-busbar 360. For example, the casing 305 can include a housing 335. The housing 335 can be disposed on an end portion 315 of the casing 305. The housing 335 can be configured to receive a fastener 405. The fastener 405 can be, for example, a bolt. The fastener 405 can be configured to couple the M-busbar 355 with the first T-busbar 360. Act 805 can also include coupling the first busbar with the third busbar. For example, the M-busbar 355 can couple with both the first T-busbar 360 and the second T-busbar 360. The first end portion 315 of the casing 305 can include a first housing to receive a first fastener 405 and the second end portion 315 of the casing 305 can include a second housing to receive a second fastener 405. The first fastener 405 can couple the M-busbar 355 with the first T-busbar 360 and the second fastener 405 can couple the M-busbar 355 with the second T-busbar 360.

Act 810 can include exposing a portion of the first busbar with a first opening. For example, the first end portion 315 of the casing 305 can define a first opening and a second opening. The first opening can be a first M-opening 330 and the second opening can be a first T-opening 345. The first M-opening 330 can be disposed on a first side of the first housing 335 and the first T-opening 345 can be disposed on a second side of the first housing 335. The first M-opening 330 can be configured to expose a portion of the M-busbar 355. For example, the M-busbar 355 can be disposed in a cavity 410 of the casing 305. The M-opening 330 can extend through a surface of the casing 305 to expose the portion of the M-busbar 355. Act 810 can also include exposing a second portion of the first busbar. For example, a second end portion 315 of the casing can define a third opening and a fourth opening. The third opening can be a second M-opening 330. The fourth opening can be a second T-opening 345. The second M-opening 330 can also extend through a surface of the casing 305 to the cavity 410 of the casing 305. The first M-opening 330 can expose a first portion of the M-busbar 355 and the second M-opening 330 can expose a second portion of the M-busbar 355.

Act 815 can include exposing a portion of the second busbar. The second busbar can be the first T-busbar 360. The second opening of the first end portion 315 can be the first T-opening 345. The first T-opening 345 can be configured to expose a portion of the first T-busbar 360. For example, the first T-opening 345 can be defined by the first tip 325 of the first end portion 315. The bottom surface 425 of the first tip 325 can interface with the first T-busbar 360. The first T-opening 345 can extend from the top surface 420 of the first tip 325 to the bottom surface 425 of the first tip 325 to expose the portion of the first T-busbar 360. Act 815 can also include exposing a portion of the third busbar. The third busbar can be the second T-busbar 360. The fourth opening of the second end portion 315 can be the second T-opening 345. The second T-opening 345 can be configured to expose a portion of the second T-busbar 360. For example, the second T-opening 345 can be defined by the second tip 325 of the second end portion 315. The bottom surface 425 of the second tip 325 can interface with the second T-busbar 360. The second T-opening 345 can extend from the top surface 420 of second tip 325 to the bottom surface 425 of the second tip 325 to expose the portion of the second T-busbar 360.

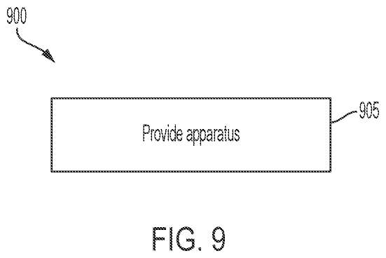

FIG. 9 depicts an example method 900 to provide an apparatus 300. Method 900 can include providing the apparatus (Act 905). Act 905 of providing the apparatus 300 can include providing a casing 305. The casing 305 can include at least one member 310 and at least one end portion 315. The casing 305 can define a cavity 410 configured to receive a first busbar. The first busbar can be M-busbar 355. The casing 305 can be integrally formed with the M-busbar 355. For example, the casing 305 can be an overmold molded with the M-busbar 355 such that the casing and the M-busbar 355 are a single component. The cavity 410 can extend along the member 310 and along a portion of the end portion 315. For example, the end portion 315 can include a tip 325. An end of the cavity 410 can be defined by a sidewall of the tip 325.

The end portion 315 can also define a plurality of openings. For example, the end portion 315 can define a first opening and a second opening. The first opening can be a M-opening 330 and the second opening can be a T-opening 345. The M-opening 330 can be defined by a projection 415 extending from a surface of the casing 305. The M-opening 330 can extend from an end of the projection 415 to the cavity 410 of the casing. The M-opening 330 can be configured to expose a portion of a first busbar. The first busbar can be a M-busbar 355. The M-busbar 355 can be configured to couple a first battery module 115 with a second battery module 115. The M-opening 330 can have an oblong shape. For example, the M-opening 330 can have an oval shape. The M-opening 330 can be any size or shape configured to receive a device to contact the exposed portion of the M-busbar 355. For example, the M-opening 330 can be configured to receive a probe. The T-opening 345 can be disposed in a tip 325 of the end portion 315. The T-opening 345 can extend from a top surface 420 of the tip 325 to a bottom surface 425 of the tip 325. The T-opening 345 can be configured to expose a portion of a second busbar. The second busbar can be a T-busbar 360. The T-busbar 360 can be configured to couple a battery module 115 with a M-busbar 355. The T-opening 345 can have a round shape. For example, the T-opening 345 can have a circular shape. The T-opening 345 can be any size or shape configured to receive a device to contact the exposed portion of the T-busbar 360. For example, the T-opening 345 can be configured to receive a probe. The M-opening 330 can be disposed closer to the member 310 than the T-opening 345.

The end portion 315 can include a housing 335. The housing 335 can be configured to receive a fastener 405. The fastener 405 can be configured to couple the M-busbar 355 with the T-busbar 360. The housing can define a housing aperture 340. The housing aperture 340 can facilitate the coupling of the M-busbar 355 with the T-busbar 360. The M-opening 330 of the end portion 315 can be disposed on a first side of the housing 335 and the T-opening 345 can be disposed on a second side of the housing 335.

The casing 305 can also include a plurality of end portions 315. For example, the casing 305 can include a first end portion 315 and a second end portion 315. The first end portion 315 can extend from a first end of the member 310 and the second end portion 315 can extend from a second end of the member 310. The first and second end portions 315 can be integrally formed with the member 310. The first end portion 315 can include a first tip 325 and the second end portion 315 can include a second tip 325. The cavity 410 can extend between the first tip 325 and the second tip 325. The first and second end portion 315 can define a plurality of openings. For example, the first end portion 315 can define a first opening and a second opening. The first opening can be a first M-opening 330 and the second opening can be a first T-opening 345. The second end portion 315 can define a third opening and a fourth opening. The third opening can be a second M-opening 330 and the fourth opening can be a second T-opening 345. The first and second M-openings 330 can be configured to expose a first and second portion of an M-busbar 355 that is disposed in the cavity 410. The first T-opening 345 can be configured to expose a portion of a first T-busbar 360 and the second T-opening 345 can be configured to expose a portion of a second T-busbar 360.

The first end portion 315 can include a first housing 335 and the second end portion 315 can include a second housing 335. The first housing 335 can be configured to receive a first fastener 405 and the second housing 335 can be configured to receive a second fastener 405. The first fastener 405 can couple the M-busbar 355 with the first T-busbar 360 and the second fastener 405 can couple the M-busbar 355 with the second T-busbar 360.

The apparatus 300 can be configured to electronically couple a first battery module 115 with a second battery module 115 and verify that the connection is proper. For example, the first T-busbar 360 can be coupled with the first battery module 115 and the second T-busbar 360 can be coupled with the second battery module 115. The apparatus 300 can extend between the first T-busbar 360 and the second T-busbar 360 to electrically couple the first T-busbar 360 with the second T-busbar 360. For example, the M-busbar 355 can be disposed in the cavity 410 of the apparatus 300. The M-busbar 355 can interface with and be coupled with the first and second T-busbars 360 to electrically couple the first battery module 115 with the second battery module 115.

To verify the connection is proper, the openings of the apparatus provide access points for devices to determine a resistance over the busbars 355, 360. For example, the first and second M-openings 330 and the first and second T-openings 345 can be configured to provide access for a device to contact the respective busbar 355, 360. By contacting the busbars at various locations, the device (e.g., a probe) can measure a resistance across the busbars 355, 360. This resistance can be compared to a threshold to determine whether the connection is proper.

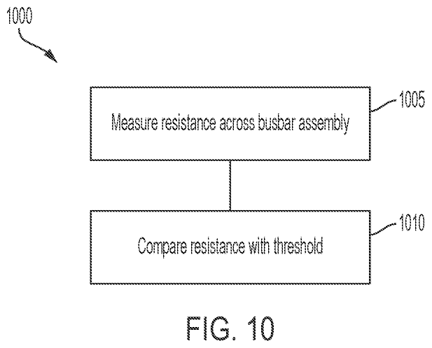

FIG. 10 depicts an example method 1000 to verify a connection. Method 1000 can include measuring resistance across a busbar assembly (Act 1005) and comparing the resistance with a threshold (Act 1010). Act 1005 of measuring resistance across a busbar assembly can include assembling a busbar assembly 400. The busbar assembly 400 can include an apparatus 300, a first busbar, and a second busbar. The apparatus 300 can be or can include a casing 305. The first busbar can be a M-busbar 355. The second busbar can be a T-busbar 360. As described in more detail above with respect to method 800, assembling a busbar assembly 400 can include a casing 305 receiving the M-busbar 355. The M-busbar 355 can be disposed in a cavity of the casing 305. The casing 305 can facilitate a coupling between the M-busbar 355 and the T-busbar 360. For example, the casing 305 can include a housing 335 to receive a fastener 405. The fastener 405 can be configured to couple the M-busbar 355 with the T-busbar 360. The busbar assembly 400 can also include a third busbar. The second busbar can be a first T-busbar 360 and the third busbar can be a second T-busbar 360. The casing 305 can also facilitate a coupling between the M-busbar 355 and the second T-busbar 360. For example, the casing 305 can include a first housing 335 to receive a first fastener 405 and a second housing 335 to receive a second fastener 405. The first fastener 405 can couple the M-busbar 355 with the first T-busbar 360 and the second fastener 405 can couple the M-busbar 355 with the second T-busbar 360.

Act 1005 can include measuring a resistance across the busbar assembly 400. Measuring a resistance can include other forms of measurement to determine a faultiness in a connection (e.g., measuring a difference in current at different locations). A resistance can be measured between the first busbar and the second busbar. For example, a resistance can be measured between the M-busbar 355 and the first T-busbar 360. The casing 305 can include a first opening and a second opening to facilitate the measuring of the resistance. The first opening can be a M-opening 330 and the second opening can be a T-opening. The M-opening 330 can expose a portion of the M-busbar 355 such that a device (e.g., a probe) can contact the M-busbar 355. The T-opening 345 can expose a portion of the first T-busbar 360 such that a device can contact the T-busbar 360. The M-opening can be on first side of the first housing 335 and the T-opening can be on a second side of the first housing 335. The openings 330, 345 enable the device to measure a resistance between the M-busbar 355 and the first T-busbar 360 across a connection point created by the fastener 405.

A resistance can be measured between the first busbar and the third busbar. For example, a resistance can be measured between the M-busbar 355 and the second T-busbar 360. The casing 305 can also include a third opening and a fourth opening to facilitate the measuring of the resistance. The first opening can be a first M-opening 330, the second opening can be a first T-opening, the third opening can be a second M-opening 330, and the fourth opening can be a second T-opening 345. The first opening can expose a first portion of the M-busbar 355. The second M-opening 330 can expose a second portion of the M-busbar 355 such that a device (e.g., a probe) can contact the M-busbar 355. The second T-opening 345 can expose a portion of the second T-busbar 360 such that a device can contact the second T-busbar 360. The second M-opening can be on first side of the second housing 335 and the second T-opening can be on a second side of the second housing 335. The second openings 330, 345 enable the device to measure a resistance between the M-busbar 355 and the second T-busbar 360 across a connection point created by the second fastener 405.

A resistance can be measured between the second busbar and the third busbar. For example, a resistance can be measured across the entire busbar assembly 400. The first T-opening 345 can expose a portion of the first T-busbar 360 and the second T-opening 345 can expose a portion of the second T-busbar 360. A device can contact the first and second T-busbars 360 via the first and second T-openings, respectively. The first and second T-openings 345 enable the device to measure a resistance between the first T-busbar 360 and the second T-busbar 360.

Act 1010 can include comparing at least one resistance with a threshold. The threshold can identify when a physical connection between two busbars is adequate. For example, if the resistance is below the threshold, the connection can be determined as adequate. If the resistance is above the threshold, the connection can be determined to be inadequate. The threshold can be a predetermined value. For example, the threshold can be twenty micro-ohms. The threshold can be more or less than 20 micro-ohms.

Some of the description herein emphasizes the structural independence of the aspects of the system components or groupings of operations and responsibilities of these system components. Other groupings that execute similar overall operations are within the scope of the present application. The systems described above can provide multiple of any or each of those components and these components can be provided on either a standalone system or on multiple instantiations in a distributed system.

While operations are depicted in the drawings in a particular order, such operations are not required to be performed in the particular order shown or in sequential order, and all illustrated operations are not required to be performed. Actions described herein can be performed in a different order.

Having now described some illustrative implementations, it is apparent that the foregoing is illustrative and not limiting, having been presented by way of example. In particular, although many of the examples presented herein involve specific combinations of method acts or system elements, those acts and those elements may be combined in other ways to accomplish the same objectives. Acts, elements and features discussed in connection with one implementation are not intended to be excluded from a similar role in other implementations or implementations.

The phraseology and terminology used herein is for the purpose of description and should not be regarded as limiting. The use of “including” “comprising” “having” “containing” “involving” “characterized by” “characterized in that” and variations thereof herein, is meant to encompass the items listed thereafter, equivalents thereof, and additional items, as well as alternate implementations consisting of the items listed thereafter exclusively. In one implementation, the systems and methods described herein consist of one, each combination of more than one, or all of the described elements, acts, or components.

Any references to implementations or elements or acts of the systems and methods herein referred to in the singular may also embrace implementations including a plurality of these elements, and any references in plural to any implementation or element or act herein may also embrace implementations including only a single element. References in the singular or plural form are not intended to limit the presently disclosed systems or methods, their components, acts, or elements to single or plural configurations. References to any act or element being based on any information, act or element may include implementations where the act or element is based at least in part on any information, act, or element.

Any implementation disclosed herein may be combined with any other implementation or embodiment, and references to “an implementation,” “some implementations,” “one implementation” or the like are not necessarily mutually exclusive and are intended to indicate that a particular feature, structure, or characteristic described in connection with the implementation may be included in at least one implementation or embodiment. Such terms as used herein are not necessarily all referring to the same implementation. Any implementation may be combined with any other implementation, inclusively or exclusively, in any manner consistent with the aspects and implementations disclosed herein.

References to “or” may be construed as inclusive so that any terms described using “or” may indicate any of a single, more than one, and all of the described terms. References to at least one of a conjunctive list of terms may be construed as an inclusive OR to indicate any of a single, more than one, and all of the described terms. For example, a reference to “at least one of ‘A’ and ‘B’” can include only ‘A’, only ‘B’, as well as both ‘A’ and ‘B’. Such references used in conjunction with “comprising” or other open terminology can include additional items.

Where technical features in the drawings, detailed description or any claim are followed by reference signs, the reference signs have been included to increase the intelligibility of the drawings, detailed description, and claims. Accordingly, neither the reference signs nor their absence have any limiting effect on the scope of any claim elements.

Modifications of described elements and acts such as variations in sizes, dimensions, structures, shapes and proportions of the various elements, values of parameters, mounting arrangements, use of materials, colors, orientations can occur without materially departing from the teachings and advantages of the subject matter disclosed herein. For example, elements shown as integrally formed can be constructed of multiple parts or elements, the position of elements can be reversed or otherwise varied, and the nature or number of discrete elements or positions can be altered or varied. Other substitutions, modifications, changes and omissions can also be made in the design, operating conditions and arrangement of the disclosed elements and operations without departing from the scope of the present disclosure.

For example, descriptions of positive and negative electrical characteristics may be reversed. Elements described as negative elements can instead be configured as positive elements and elements described as positive elements can instead by configured as negative elements. For example, elements described as having first polarity can instead have a second polarity, and elements described as having a second polarity can instead have a first polarity. Further relative parallel, perpendicular, vertical or other positioning or orientation descriptions include variations within +/−10% or +/−10 degrees of pure vertical, parallel or perpendicular positioning. References to “approximately,” “substantially” or other terms of degree include variations of +/−10% from the given measurement, unit, or range unless explicitly indicated otherwise. Coupled elements can be electrically, mechanically, or physically coupled with one another directly or with intervening elements. Scope of the systems and methods described herein is thus indicated by the appended claims, rather than the foregoing description, and changes that come within the meaning and range of equivalency of the claims are embraced therein.

What is claimed is:

1. An apparatus, comprising:
a member; and
an end portion disposed at an end of the member, the end portion comprising a first opening and a second opening, the first opening configured to expose a portion of a first busbar and the second opening configured to expose a portion of a second busbar, the first busbar configured to couple with the second busbar.

2. The apparatus of claim 1, comprising:
the end portion is integrally formed with the member, the end portion comprising:
a body defining at least a portion of a cavity, the body comprising a projection extending from a surface of the body, the first opening extending from an end of the projection to the cavity; and
a tip comprising a top surface and a bottom surface, the second opening extending from the top surface to the bottom surface;
the cavity is configured to receive the first busbar and the tip is configured to interface with the second busbar.

3. The apparatus of claim 1, comprising:
the end portion, comprising:
a projection defining the first opening;
a housing configured to receive a fastener, the fastener configured to couple the first busbar with the second busbar; and
a tip defining the second opening;
the projection disposed on a first side of the housing and the tip disposed on a second side of the housing.

4. The apparatus of claim 1, comprising:
the end portion comprising a housing, the housing comprising an aperture, the housing configured to receive a fastener and the aperture configured to facilitate securing of the fastener to couple the first busbar with the second busbar.

5. The apparatus of claim 1, comprising:
the first opening comprising a first shape and the second opening comprising a second shape, the first shape different than the second shape.

6. The apparatus of claim 1, comprising:
a plurality of end portions comprising a first end portion and a second end portion;
the first end portion defining the first opening and the second opening;
the second end portion defining a third opening and a fourth opening;
the first opening to expose a first portion of the first busbar, the second opening to expose a portion of the second busbar, the third opening to expose a second portion of the first busbar, and the fourth opening to expose a portion of a third busbar, the third busbar configured to couple with the first busbar.

7. The apparatus of claim 1, comprising:
a plurality of end portions comprising a first end portion and a second end portion, the first end portion comprising a first tip and the second end portion comprising a second tip;
the member, the first end portion, and the second end portion to define a cavity, the cavity configured to receive the first busbar, the cavity to extend between the first tip and the second tip.

8. The apparatus of claim 1, comprising:
a plurality of end portions comprising a first end portion and a second end portion, the first end portion defining the first opening and the second opening and the second end portion defining a third opening and a fourth opening;
the first opening and the third opening disposed a first distance away from a centerline of the apparatus and the second opening and the fourth opening disposed a second distance away from the centerline of the apparatus.

9. The apparatus of claim 1, comprising:
the first opening comprising an oblong shape; and
the second opening comprising a round shape.

10. The apparatus of claim 1, comprising:
the first busbar configured to couple a first battery module with a second battery module; and
the second busbar configured to couple the first busbar with at least one of the first battery module and the second battery module.

11. The apparatus of claim 1, comprising:
the first opening having a first depth and the second opening having a second depth, wherein the first depth is less than the second depth.

12. The apparatus of claim 1, wherein the member is an elongated portion configured to extend between the second busbar and a third busbar, the second busbar coupled with a first battery module and the third busbar coupled with a second battery module;
the elongated portion defining a cavity configured to receive the first busbar, wherein the first busbar interfaces with the second busbar and the third busbar;
the first, second, and third busbars configured to electrically couple the first battery module with the second battery module.

13. The apparatus of claim 1, comprising:
a plurality of end portions comprising a first end portion and a second end portion, the first end portion defining the first opening and the second opening and the second end portion defining a third opening and a fourth opening, the first opening closer to a centerline of the apparatus than the second opening and the third opening closer to the centerline of the apparatus than the fourth opening; and
the member is an elongated portion disposed between the first opening and the second opening.

14. A battery pack, comprising:
a battery module; and
a busbar assembly coupled with the battery module, the busbar assembly comprising:
a first busbar;
a second busbar coupled with the first busbar; and
a casing configured to receive the first busbar and interface with the second busbar, the casing comprising a plurality of openings, the plurality of openings comprising a first opening and a second opening, the first opening exposing a portion of the first busbar and the second opening exposing a portion of the second busbar.

15. The battery pack of claim 14, comprising:
the casing, comprising:
a member; and
a plurality of end portions comprising a first end portion disposed at a first end of the member and a second end portion disposed at a second end of the member;
the first opening and the second opening defined by one of the first end portion and the second end portion.

16. The battery pack of claim 14, comprising:
the casing comprising a first end portion and a second end portion;
the first end portion defining the first opening and the second opening; and
the second end portion defining a third opening and a fourth opening, the first opening and the third opening having an oblong shape and the second opening and the fourth opening having a circular shape.

17. The battery pack of claim 14, comprising:
the busbar assembly including a third busbar coupled with the first busbar;
the battery module being a first battery module, the battery pack comprising a second battery module coupled with the busbar assembly via the third busbar;
the casing comprising the first opening, the second opening, a third opening, and a fourth opening, the first opening exposing a first portion of the first busbar, the second opening exposing the portion of the second busbar, the third opening exposing a second portion of the first busbar, and the fourth opening exposing a portion of the third busbar.

18. A method, comprising:
coupling a first busbar with a second busbar;
exposing a portion of the first busbar with a first opening of a casing; and
exposing a portion of the second busbar with a second opening of the casing.

19. The method of claim 18, comprising:
receiving, by a cavity of the casing, the first busbar, the casing comprising:
a member; and
an end portion disposed at an end of the member, the end portion defining the first opening and the second opening;
interfacing the end portion of the casing with the second busbar;

20. The method of claim 18, wherein the casing comprises a first end portion and a second end portion, the first end portion defining the first opening and the second opening and the second end portion defining a third opening and a fourth opening, the method comprising:
coupling the first busbar with a third busbar;
exposing a first portion of the first busbar with the first opening;
exposing the portion of the second busbar with the second opening;
exposing a second portion of the first busbar with the third opening; and
exposing a portion of the third busbar with the fourth opening.
